(19) United States
(12) Patent Application Publication
(10) Pub. No.: US 2007/0070385 A1
(43) Pub. Date: Mar. 29, 2007

(54) Data processing apparatus

(75) Inventors: Yuji Okamoto, Kyoto (JP); Naofumi Ueda, Kyoto (JP); Shunsuke Yajima, Nara (JP); Syoichiro Yoshiura, Nara (JP)

Correspondence Address: EDWARDS & ANGELL, LLP, P.O. BOX 55874, BOSTON, MA, 02205, US

(73) Assignee: Sharp Kabushiki Kaisha, Osaka (JP)

(21) Appl. No.: 11/505,776

(22) Filed: Aug. 16, 2006

(30) Foreign Application Priority Data
Sep. 16, 2005 (JP) 2005-269594

(51) Int. Cl. G06K 15/00

(52) U.S. Cl. 358/1.14; 358/1.16

(57) ABSTRACT

Image data in local memory is constantly erased to prevent leakage of old image data on the occurrence of a trouble. Input image data is stored in a used area of local memory. When processing of the image data is completed, a data erasure task is executed to erase the image data in the local memory. If new image data is input during the execution of the data erasure task, the data erasure task is stopped. When processing of the new image data is completed, the data erasure task is resumed from the stopped position.

### BACKGROUND OF THE INVENTION

The present invention relates to a data processing apparatus that stores input image data and subjects the image data to processing such as printing, image communication, and facsimile communication.

Among data processing apparatus with a copy function for electronically scanning and reading an image on a document and copying image data, those combining several functions have been increasing in recent years. For example, such a data processing apparatus may have the following functions: a network printer function for connecting to a network such as a LAN, receiving image data from an information processing apparatus such as a personal computer, and printing an image; a network scanner function for reading image data and transmitting the image data to an information processing apparatus; and a facsimile function for transmitting and receiving image data to and from an external facsimile machine via a network or a telephone line.

A data processing apparatus with several functions includes a storage device for temporarily storing input image data. Various types of storage devices exist, including those made of semiconductor memory and those implemented as a magnetic storage medium such as a hard disk device. These storage devices allow efficient processing of a large amount of image data and a plurality of jobs.

In a data processing apparatus, semiconductor memory with a fast read/write capability is used as local memory for storing image data being processed, and a hard disk device is used for temporarily saving image data to be processed. Input image data is subjected to image processing such as compression in the local memory and then temporarily saved in the hard disk device. When the turn comes for the image data to be processed, the saved image data is read and subjected to image processing such as decompression in the local memory. The image data is further subjected to desired processing, such as processing for printing, image communication, or facsimile communication, and then output to the outside.

When sensitive data is processed in such a data processing apparatus, security measures are taken. For example, on completion of the processing, the image data in the hard disk device is erased or overwritten with random data as described in Japanese Patent Laid-Open No. 9-284572. Further, the erasure is repeated several times as described in Japanese Patent Laid-Open No. 2004-7059. Thus, the image data saved in the hard disk device is made completely unreadable and is invalidated.

### BRIEF SUMMARY OF THE INVENTION

For local memory implemented using volatile memory, image data is stored by overwriting old image data with new image data. When the power supply for the local memory is shut off, the image data is erased. However, in the case where the data processing apparatus is used round-the-clock, the power is always on and therefore the local memory always contains image data.

Here, a trouble may occur in the data processing apparatus due to a noise or an incorrectly sensed document, resulting in that image data input may get out of order, or image data input may be falsely detected although no image data is input. Then, processing goes on without overwriting the old image data stored in the local memory. This causes a problem, for example that the previously input image is printed, and gives the user security concern.

In the light of the above issues, the present invention aims to provide a data processing apparatus that invalidates image data in local memory to prevent leakage of old image data in the event of a trouble.

The present invention comprises: storage means implemented as local memory that stores image data inputted for image data processing; invalidation means that in validates the image data stored in the storage means; and control means that causes the invalidation means to operate when the processing is completed. During the operation of the invalidation means, the control means suspends the operation when new processing is started and resumes the operation when the new processing is completed. The control means causes the invalidation means to operate on confirmation that no more image data is stored in the storage means.

In this manner, the invalidation means is executed when no image data processing is being performed. Therefore, the image data stored in the storage means is constantly invalidated, and old image data will never be falsely output.

A used area to which image data is written is created in the storage means. The invalidation means starts invalidation of the image data from the head of the used area. The control means records a stopped position when the operation of the invalidation means is stopped, and starts the operation from the stopped position when the operation is resumed. Thus, resuming the invalidation from the suspension location allows invalidation of the image data left without being invalidated.

The head of the used area is fixed, and the end of the used area is variable depending on the input image data. That is, the invalidation means will repeatedly invalidate the same area. Therefore, the control means causes the invalidation means to operate to invalidate from the stopped position to the end of the maximum used area when the operation is resumed. This allows invalidation of all image data stored in the storage means.

Further, when the operation is resumed, the control means causes the invalidation means to operate to invalidate to the end of the used area and then invalidate from the head to the stopped position. Newly input image data is stored from the head of the used area. When the invalidation is resumed, the image data from the head to the stopped position will not be invalidated. However, operating in this manner allows invalidation of the newly stored image data as well.

The storage means may comprise input storage means in which input image data is stored for processing, and output storage means in which image data to be output is stored for processing. Still in this case, the control means causes the invalidation means to operate for each of the storage means as described above.

According to the present invention, the invalidation means operates to invalidate the image data stored in the local memory whenever image data processing is not being performed. Therefore, there will be no output of old image data remaining in the local memory. This can prevent leakage of image data, thereby enhancing security in the data processing apparatus.

### BRIEF DESCRIPTION OF THE DRAWINGS

FIG. 1 is a diagram showing a schematic configuration of a digital multifunction machine, which is an embodiment of a data processing apparatus of the present invention;

FIG. 2 is a control block diagram for image data invalidation;

FIG. 3 is a flowchart starting with processing of input image data and ending with erasure of the image data;

FIG. 4 is a diagram showing a job management table for processing of input image data; and

FIG. 5 is a diagram showing the state of storage and erasure of image data in the local memory.

### DETAILED DESCRIPTION OF THE INVENTION

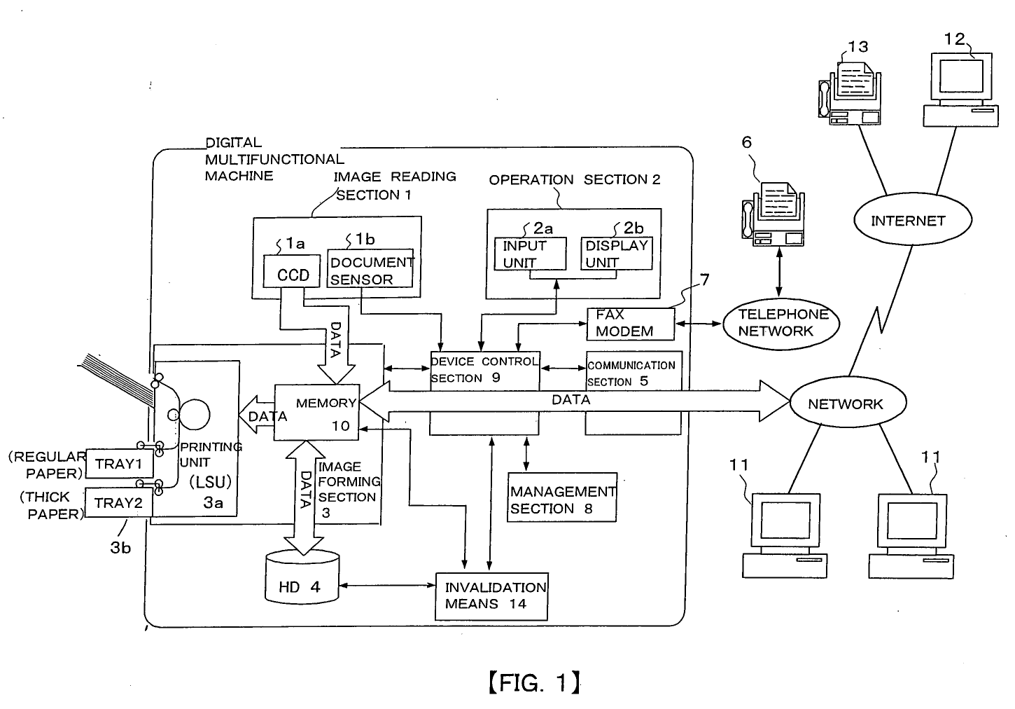

FIG. 1 shows a data processing apparatus in an embodiment. The data processing apparatus is a digital multifunctional machine having copy mode, printer mode, scanner mode, and facsimile mode. The data processing apparatus includes: an image reading section 1 that reads a document and inputs image data; an operation section 2 that receives user inputs; an image forming section 3 that prints image data; a hard disk device 4 that saves image data; a communication section 5 that communicates with external apparatus; a fax modem 7 for communicating with a facsimile machine 6; a management section 8 that stores information such as control information and setting information about the entire apparatus; and a device control section 9 responsible for controlling the entire apparatus.

The image reading section 1 functions as data input means for inputting image data and includes an image pickup device such as a CCD 1a, and a document sensor 1b that senses a document placed on a document platform or on an automatic document feeder (ADF). The image data read by the CCD 1a is output to the image forming section 3.

The operation section 2 includes an input portion 2a consisting of various input keys, and a display portion 2b such as a liquid crystal display. The operation section 2 allows operations for the entire apparatus and inputting of various settings, and displays the input content and the operational state of the entire apparatus.

The image forming section 3 has a local memory 10 as storage means for storing image data, a printing portion 3a implemented as a laser scanning unit, and a paper feeding portion 3b. The local memory 10 is implemented using readable/writable semiconductor memory, such as SDRAM or flash memory. The local memory 10 stores image data by overwriting old image data with new image data. The printing portion 3a prints an image on a recording sheet that is fed from the paper feeding portion 3b based on the image data stored in the local memory 10.

In the image forming section 3, input image data is stored in the local memory 10, in which the image data is subjected to image processing such as compression, decompression, or modification. The processed image data is output to the printing portion 3a, the hard disk device 4, or the device control section 9. The local memory 10 is divided into an input data area for storing input image data, and an output data area for storing image data to be output. Instead of using a single divided local memory 10, two units of local memory 10 may be used for input and output, respectively.

The hard disk device 4 is saving means for temporarily saving image data to be processed. When image data is saved in the hard disk device 4, the image data is encrypted as necessary.

The communication section 5 is connected to a router, switching hub or the like via a LAN cable, and further connected to a network formed by information processing apparatus 11 such as personal computers and servers. The network is connected to the Internet via a telephone network or via a communication line such as a fiber-optic line. The communication section 5 transmits and receives data to and from the information processing apparatus 11 in the network, and to and from external information processing apparatus 12 and facsimile machine 13 over the Internet. The fax modem 7 is connected to a telephone network via a telephone line and performs facsimile communication with the external facsimile machine 6. Thus, since image data is input via the communication section 5 and the fax modem 7, they also function as data input means.

In response to an input from the operation section 2 or a data input from an external apparatus, the device control section 9 controls relevant components based on information stored in the management section 8 and processes the input image data. That is, the input image data is processed in either of copy mode, printer mode, scanner mode, or facsimile mode and is output in a desired form.

The data processing apparatus further includes invalidation means 14 for invalidating image data in the local memory 10 and the hard disk device 4. The device control section 9 controls operation of the invalidation means 14. Invalidation of image data means to make stored image data unreadable by overwriting the image data with random data or meaningless data or by erasing the image data so that the original image cannot be reproduced. Therefore, the invalidation means 14 invalidates image data in the local memory 10 by overwriting the old image data or by erasing the data, and invalidates image data in the hard disk device 4 by overwriting or erasing the image data.

Now, operations in each mode will be described. In copy mode, image data of a document that is read by the image reading section 1 is output as a copy from the image forming section 3. Specifically, an image of a document placed at a reading position is read by the CCD 1a. The image data that is output from the CCD 1a is made up into an outputting image in the local memory 10 and sent to the hard disk device 4 to be temporarily saved there. For a plurality of documents, this reading and storage operation is repeated.

Then, based on processing indications provided from the operating section 2, the image data saved in the hard disk device 4 is sequentially read in a timely manner and sent to the local memory 10. Timed to writing operations to the printing portion 3a, the image data is transferred from the local memory 10 to the printing portion 3a, and the image is printed on a recording sheet.

Similarly, if a plurality of copies of the read image data are printed, the image data is saved on a page basis in the hard disk device 4 as outputting images and sent from the hard disk device 4 to the local memory 10 according to the output mode. Timed to writing operations to the printing portion 3a, the image data in the local memory 10 is repeatedly transferred to the printing portion 3a as many times as the number of copies to be output.

In printer mode, image data that is output from the information processing apparatus 11 or 12 is output from the image forming section 3. That is, the image data from the information processing apparatus 11 or 12 is received by the communication section 5. The device control section 9 sends the input image data to the local memory 10, decompresses the image data on a page basis as outputting image data, and temporarily saves the image data in the hard disk device 4. The image data is sent from the hard disk device 4 to the local memory 10, and transferred to the printing portion 3a as in the case of copy mode, and the image is printed.

In scanner mode, image data of a document that is read in the image reading section 1 is communicated to any of the information processing apparatus 11 and 12 over the network. That is, the image data that is output from the CCD 1a is made up into an outputting image in the local memory 10 and temporarily saved in the hard disk device 4. The image data is sent from the hard disk device 4 to the local memory 10. The device control section 9 establishes communication with a recipient in the network specified via the operation section 2 and transmits the image data from the communication section 5 to the recipient. The image data may also be transmitted to the external information processing apparatus 12 or the facsimile machine 13 from the communication section 5 over the network and the Internet. By similar operations, in facsimile mode, the device control section 9 transmits image data from the fax modem 7 to the facsimile machine 6 via the telephone line 6.

In the processing of the image data that has been input from the data input means as described above, the image data is stored in the local memory 10. On completion of the processing of the image data, the device control section 9 activates the invalidation means 14 for the local memory 10.

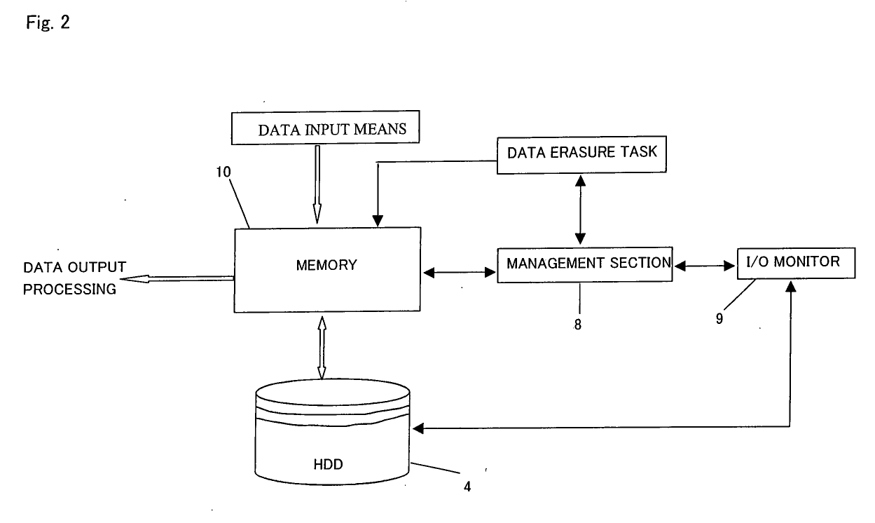

As shown in FIG. 2, the device control section 9 recognizes that no more image data is stored in the local memory 10 and determines that the processing is completed. That is, the device control section 9 functions as an input/output monitor section. The input/output monitor section measures the time before a next data input using a timer to see whether or not data is input within a certain period of time, for example, one minute. Thus, it is checked whether there is an input of image data from the data input means or an input of image dataform the hard disk device 4 for outputting. Alternatively, whether there is an input of image data may be checked based on the presence or absence of a document on the document platform or in the document reading section 1. In this manner, false determination can be avoided by providing a certain amount of time lag between when no more image data is stored in the local memory 10 and when it is determined that the processing is completed. For example, the time it takes to read image data from the hard disk device 4 is longer than that in the case of reading from semiconductor memory. As a result, the absence of image data input may be falsely determined and the invalidation means 14 may be activated even though image data is being read from the hard disk device 4. Providing the time lag avoids such false determination and prevents the invalidation means 14 from being falsely activated.

When it is determined that the processing is completed, the device control section 9 causes the invalidation means 14 to execute the data erasure task. Thus, the image data in the local memory 10 is erased, i.e., the stored image data is invalidated to be unreadable.

Also, when new image data is input during the execution of the data erasure task, the device control section 9 suspends the execution. The data erasure task is resumed when processing of the input image data is completed. The execution state of the data erasure task is monitored, and the monitoring information is stored and managed in the management section 8.

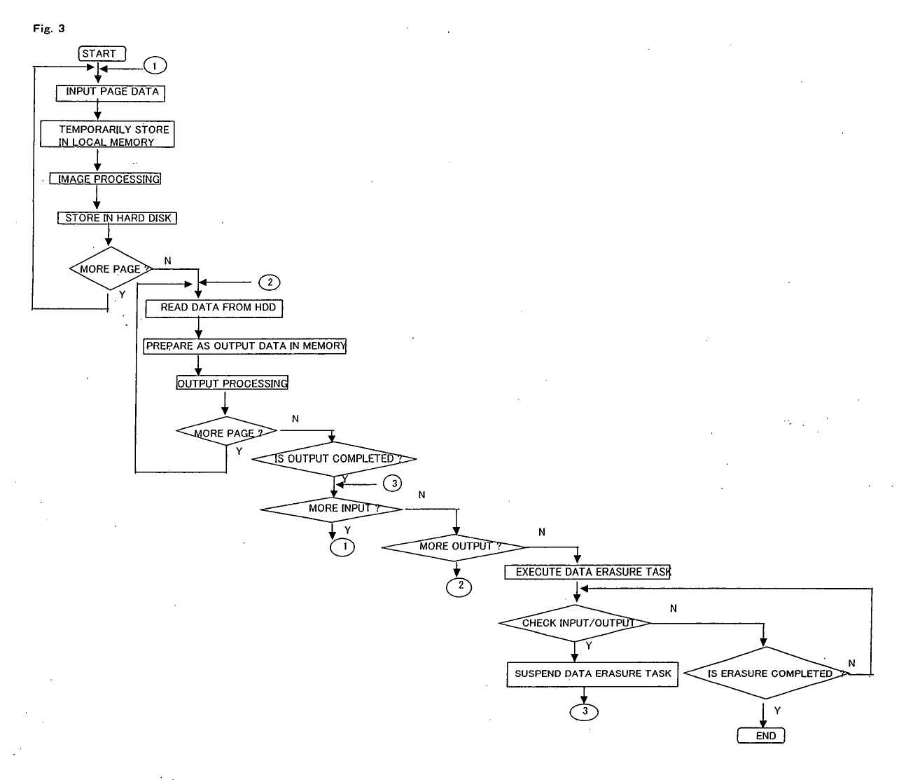

Now, the above sequence of operations from the processing of the image data to the invalidation of the image data will be described with reference to FIG. 3. First, image data is input from the data input means. The image data is input on a page basis and temporarily stored in the local memory 10. The image data is subjected to image processing and saved in the hard disk device 4. If there is a next image data, the local memory 10 is overwritten with the next image data, which is then subjected to image processing and saved in the hard disk device 4.

Once all image data has been input and saved in the hard disk device 4, processing for outputting the image data is performed according to a specified mode. The image data is read from the hard disk device 4 and deployed in the local memory 10. A specified modification is made to the image data, which is then output by means of printing, transmission, or the like. This output processing is performed for each page.

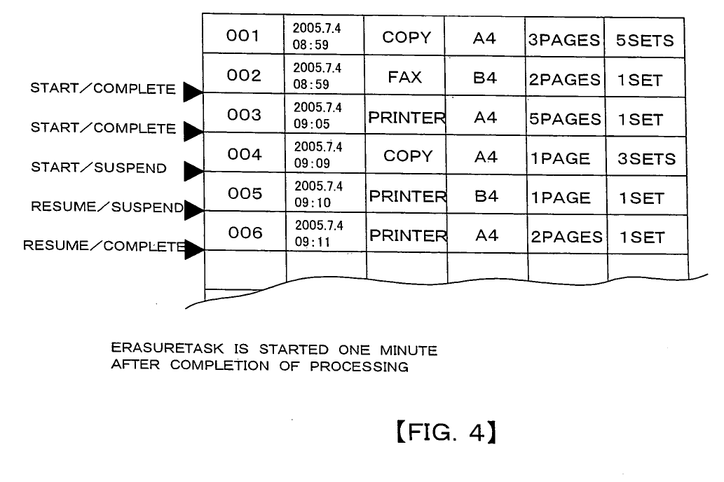

With regard to the processing of the input image data, as shown in FIG. 4, information about the processing is generated and compiled as a job management table. The job management table is stored in the management section 8. The job management table contains a state flag for a job. The state flag indicates any one of the following states; processing completed, processing underway, data erasure completed, data being erased, and erasure suspended. The state flag tells the progress of the processing of the input image data and the state of data erasure.

The processing is completed when all image data is output. If new image data is input, the next processing is started. If no image data is input, it is checked whether no image data is output. If no image data is output, it is determined that the processing is completed. Then, the data erasure task is started after a certain period of time. The execution of this task causes invalidation of the image data stored in the local memory 10.

During the execution of the data erasure task, the local memory 10 is monitored for an input or output of image data. As long as no image data is input or output, the data erasure task continues. The task terminates when all image data in the local memory 10 is erased.

If image data is input or output, the data erasure task is suspended and the image data is processed. When the processing is completed, the data erasure task is resumed. The erasure is resumed from the position where the suspension has occurred.

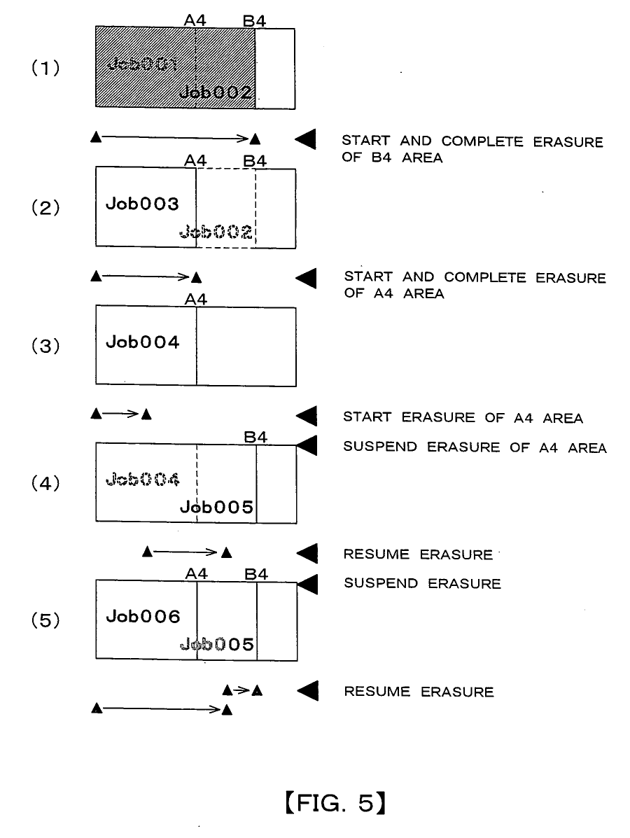

That is, as shown in FIG. 5, a used area is created in the local memory lo depending on the size of the input image data, so that the image data is written to the used area. For example, it may be an A4 area for A4-sized image data, and a B4 area for B4-sized image data. The maximum size of area may be an A3 area, in which A3-sized image data can be stored. The head of the used area is at a fixed position, whereas the end of the used area is at a variable position depending on the size of the input image data. Each position of the used area is specified by an address.

As shown in FIG. 4, it is assumed that jobs 001 to 006 are processed. As shown in FIG. 5 (1), image data for the job 001 is stored in the A4 area and subsequently overwritten with image data for the job 002, which is stored in the B4 area. Since no image data is input in a certain period of time after the completion of processing of the job 002, the data erasure task is started to erase the image data in the B4 area, and the data erasure is completed.

Then, as shown in (2), image data for the job 003 is stored in the A4 area. The image data for the job 002 has been erased at this point and is therefore indicated by a dashed line in the figure. Since no image data is input in a certain period of time after the completion of processing of the job 003, the data erasure task is executed to erase the image data in the A4 area. Then, as shown in (3), image data for the job 004 is stored in the A4 area.

The data erasure task is started a certain time after the completion of processing of the job 004. During the execution of the data erasure task, image data for the job 005 is input. Then, the data erasure task is stopped. The stopped position is recorded in the management section 8.

As shown in (4), the image data for the job 005 is stored in the B4 area. The image data for the job 004 remaining unerased is overwritten. The data erasure task is resumed a certain time after the completion of processing of the job 005. The erasure starts from the stopped position in the A4 area beyond the end of the A4 area, and the image data in the B4 area is erased. That is, the resumed data erasure task is executed so that it erases the area from the stopped position to the end of the maximum used area, i.e., the B4 area in the present case.

During the execution of the data erasure task, image data for the job 006 is input. The data erasure task is stopped and the stopped position is recorded in the management section 8. As shown in (5), the image data for the job 006 is stored in the A4 area, and part of the image data for the job 005 in the B4 area remains unerased.

The data erasure task is resumed a certain time after the completion of processing of the job 006. The erasure starts from the stopped position in the B4 area to erase the image data up to the end of the B4 area. Then, the erasure of the image data is started from the head to erase the image data up to the stopped position. This allows erasure of not only the image data left unerased at the time of suspension, but also the image data stored after suspension. As a result, all image data stored in the used area of the local memory 10 can be erased.

Thus, the data erasure task is executed during the intervals between operations of image data processing, so that the image data stored in the local memory 10 can be constantly invalidated. Therefore, even in the event of a trouble (such as occurrence of a trouble in the data processing apparatus due to a noise or an incorrectly sensed document, resulting in that image data input gets out of order, or image data input is falsely detected although no image data is input), problems such as that the previously input image is printed can be prevented because the local memory 10 does not contain old image data. The user will be free from security concern.

It is to be understood that the present invention is not limited to the above-described embodiments, but many modifications and alterations may be made to the embodiments within the scope of the present invention. The saving means for temporarily saving image data is not limited to the hard disk device but may be implemented using a recording medium removable from the apparatus, such as nonvolatile memory, an optical disk, a magnetic disk, or a magneto-optical disk.

The data processing apparatus may be a multifunctional machine with copy mode and facsimile mode, as well as a dedicated machine with single mode, such as a copier, a printer, or a facsimile machine.

If two local memory units are used for input and output respectively, the invalidation means is individually operated for each local memory unit. Furthermore, the hard disk device may also be preferably invalidated when the local memory is invalidated.

What is claimed is:

1. A data processing apparatus comprising:
storage means that stores image data input for image data processing;
invalidation means that invalidates the image data stored in the storage means; and
control means that causes the invalidation means to operate when the processing is completed,
wherein during the operation of the invalidation means, the control means suspends the operation when new processing is started and resumes the operation when the new processing is completed.

2. The data processing apparatus according to claim 1, wherein the control means causes the invalidation means to operate on confirmation that no more image data is stored in the storage means.

3. The data processing apparatus according to claim 1, wherein
a used area to which image data is written is created in the storage means,
the invalidation means starts invalidation of the image data from the head of the used area, and
the control means records a stopped position when the operation of the invalidation means is stopped, and starts the operation from the stopped position when the operation is resumed.

4. The data processing apparatus according to claim 3, wherein
the head of the used area is fixed and the end of the used area is variable depending on the input image data, and
the control means causes the invalidation means to operate to invalidate from the stopped position to the end of the maximum used area when the operation is resumed.

5. The data processing apparatus according to claim 4, wherein when the operation is resumed, the control means causes the invalidation means to operate to invalidate to the end of the used area and then invalidate from the head to the stopped position.

6. The data processing apparatus according to any of claims 1 to 5, wherein
the storage means comprises input storage means in which input image data is stored for processing, and output storage means in which image data to be output is stored for processing, and
the control means causes the invalidation means to operate for each of the storage means.
